(19) United States
(12) Patent Application Publication
(10) Pub. No.: US 2026/0104944 A1
(43) Pub. Date: Apr. 16, 2026

(54) RECONFIGURABLE AND ACCELERATED TRANSCEDENTAL FUNCTIONS

(71) Applicant: Advanced Micro Devices, Inc., Santa Clara, CA (US)

(72) Inventors: Gurunath Anandrao KADAM, Austin, TX (US); Johannes Manfred DIETERICH, Austin, TX (US)

(21) Appl. No.: 18/915,190

(22) Filed: Oct. 14, 2024

(51) Int. Cl. G06F 9/50

(52) U.S. Cl. CPC G06F 9/5077; G06F 9/5027

(57) ABSTRACT

Embodiments herein describe a processor including a plurality of compute units each having multiple reconfigurable hardware function units configured to identify transcendental functions from one or more bitstreams and execute, at runtime, the identified transcendental functions on an accelerated path. The processor may be a graphics processing unit (GPU). The accelerated path is different than paths used to process existing GPU instructions. The multiple reconfigurable hardware function units may be programmed with a table and addition based accelerated function.

### TECHNICAL FIELD

Examples of the present disclosure generally relate to integrated circuits, and, in particular, to accelerating processing of transcendental functions in graphics processing units (GPUs).

### BACKGROUND

In the realm of computer graphics, scientific computing, and machine learning, transcendental functions such as exponential, logarithmic, trigonometric, and hyperbolic functions are fundamental. Traditionally, the evaluation of these functions has been performed on central processing units (CPUs). However, CPUs, while versatile, are not optimized for the massive parallelism required to handle the large-scale, high-throughput demands of modern applications efficiently. As a result, the performance of applications relying heavily on transcendental functions can be significantly hampered when using traditional CPU-based methods. Graphics processing units (GPUs) have emerged as powerful computational platforms capable of handling parallel processing tasks far more efficiently than CPUs. Originally designed for rendering graphics, GPUs are now widely used in general-purpose computing (GPGPU) due to their highly parallel structure, which makes them well-suited for tasks that can be decomposed into smaller, independent computations. Despite their potential, the direct evaluation of transcendental functions on GPUs poses challenges.

### SUMMARY

One embodiment described herein is a system that includes at least one physical processor and physical memory comprising computer-executable instructions that, when executed by the physical processor, cause the physical processor to identify transcendental functions from one or more bitstreams, and execute, at runtime, the identified transcendental functions on an accelerated path.

One embodiment described herein is a non-transitory computer-readable medium storing instructions that, when executed by a processor, cause the processor to identify, at compile time, transcendental functions from one or more bitstreams, and execute, at runtime, the identified transcendental functions on an accelerated path different than paths used to process existing GPU instructions.

One embodiment described herein is a method including identifying transcendental functions from one or more bitstreams and executing, at runtime, the identified transcendental functions on an accelerated path.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a graphics processing unit (GPU) including a plurality of compute units, where each compute unit includes multiple reconfigurable hardware function units, according to an example.

FIG. 2 illustrates identifying transcendental functions during compile time and executing the transcendental functions on an accelerated path during runtime, according to an example.

FIG. 3 illustrates using a hardware-based scheduler to allocate the execution of the transcendental functions to one or more of the multiple reconfigurable hardware function units, according to an example.

FIG. 4 illustrates a flowchart for identifying transcendental functions, according to an example.

FIG. 5 illustrates a flowchart for sorting transcendental functions, according to an example.

FIG. 6 illustrates a flowchart for executing the transcendental functions on an accelerated path, according to an example.

FIG. 7 illustrates a method for implementing the GPU of FIG. 1, according to an example.

FIG. 8 is a block diagram of an accelerator unit (AU) configured to execute workloads for applications running on a processing system, in accordance with some embodiments.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

A transcendental function is a type of function that is not algebraic. An algebraic function is one that can be defined as the root of a polynomial equation whose coefficients are themselves polynomials. In contrast, transcendental functions are not solutions to such polynomial equations and typically exhibit more complex and non-repetitive behavior. Common examples of transcendental functions include exponential functions, logarithmic functions, trigonometric functions, and hyperbolic functions. Transcendental functions may be processed using a graphics processing unit (GPU).

A GPU is a specialized processor designed to accelerate the rendering of images, animations, and video for display. While initially developed for rendering graphics in video games, GPUs are now widely used for various parallel processing tasks. The key components of a GPU include cores, memory, shaders, and a graphics pipeline.

Currently, on GPUs, transcendental functions are evaluated using mathematical series, such as Taylor series. These mathematical series typically require N number of GPU instructions (N increases based on the required accuracy). A large N has several consequences such as increased execution time of the transcendental function, reducing overall GPU performance, increased number of required registers, increasing register pressure, and increased number of required floating point units (FPUs), increasing FPU pressure. The limited number of shared FPUs may further increase the execution time of transcendental functions.

The example embodiments disclose a system and method to accelerate processing of transcendental functions on GPUs. The system and method involves using transcendental functions on reconfigurable hardware on GPUs. Each compute unit (CU) will have a set of reconfigurable hardware (HW) function units. The number of reconfigurable HW function units per CU are determined based on the available chip area and power budget. The reconfigurable HW function unit(s) will be programmed at runtime to execute the transcendental functions via an accelerated path. The accelerated path may be referred to as an accelerated data path. The proposed reconfigurable transcendental hardware function unit executes transcendental functions on an accelerated path. The reconfigurable hardware is programmed with a Tables-and-addition-based accelerated function to execute the transcendental functions. The advantages of such configuration include faster processing of the transcendental functions on the GPU, executing the transcendental function processing on an accelerated path, and decreasing pressure on the FPUs and registers of the GPU.

The advantages of processing transcendental functions on reconfigurable HW function units include making the GPU faster, as the reconfigurable HW function units use an accelerated path that is different than the paths used for existing GPU instructions. As such, processing transcendental functions on reconfigurable HW function units does not consume GPU instruction scheduling resources and lessens the pressure on floating point units (FPUs) and registers of the GPU.

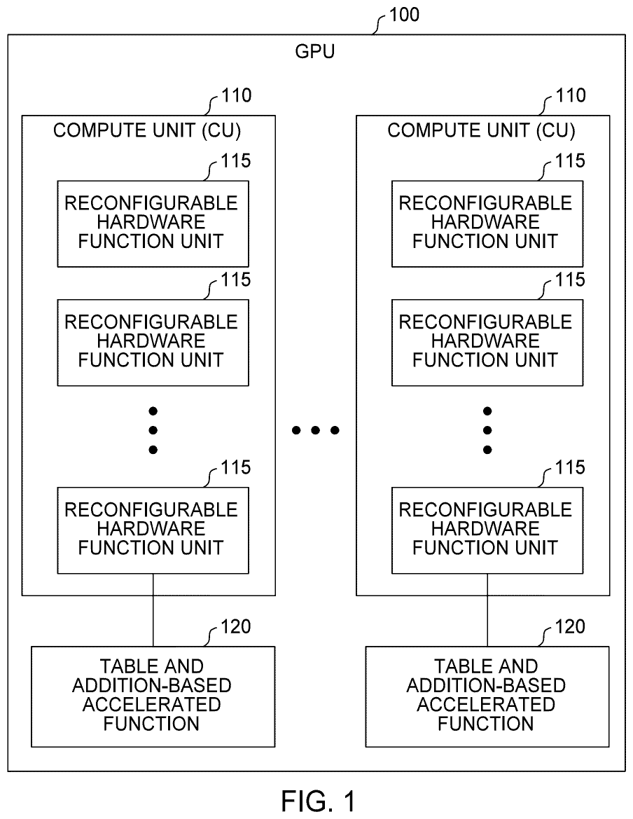

FIG. 1 illustrates a graphics processing unit (GPU) including a plurality of compute units, where each compute unit includes multiple reconfigurable hardware function units, according to an example.

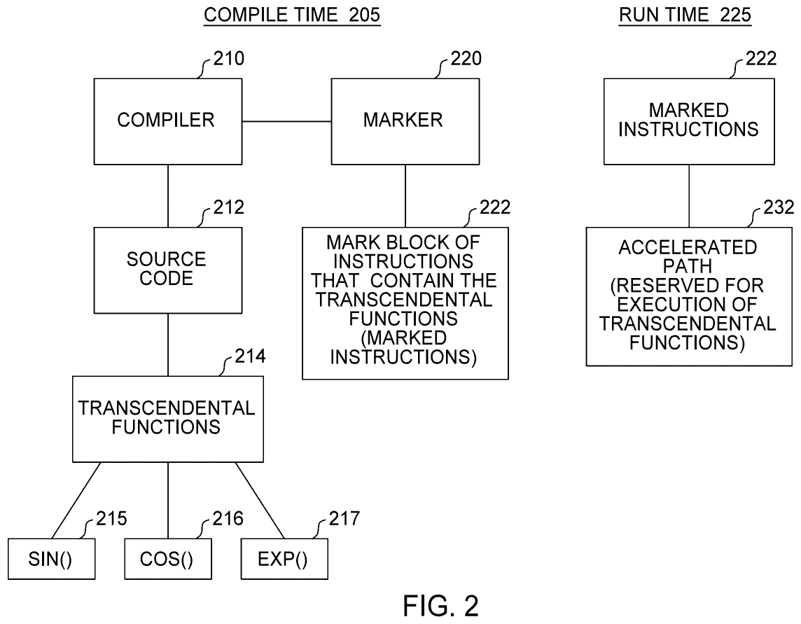

The GPU 100 can accelerate graphics rendering and parallel processing tasks. The GPU 100 can include multiple components, such as, but not limited to, compute units (CUs), control units, graphics and compute pipelines, and reconfigurable hardware. The GPU 100 includes a plurality of CUs 110, where each CU of the plurality of CUs 110 includes multiple reconfigurable hardware function units 115. The multiple reconfigurable hardware function units 115 are executed on an accelerated path 232 (FIG. 2).

The plurality of CUs 110 are the primary computational units within the GPU 100. The plurality of CUs 110 execute the actual processing of data, performing various tasks. The plurality of CUs 110 further include multiple reconfigurable hardware function units 115 that are used to execute specialized tasks. In the example embodiments, the multiple reconfigurable hardware function units 115 execute transcendental functions.

Reconfigurable hardware refers to computing hardware that can be dynamically altered to perform different tasks or optimize for different types of workloads after it has been manufactured. Unlike traditional hardware, which has a fixed architecture and functionality, reconfigurable hardware can be programmed and reprogrammed to change its configuration and behavior. The most common types of reconfigurable hardware are field-programmable gate arrays (FPGAs) and programmable logic devices (PLDs). The benefits of reconfigurable hardware include flexibility, performance, rapid prototyping, and cost-effectiveness. The ability to reprogram the hardware allows for updates and modifications without changing the physical hardware. This is particularly useful in applications where requirements change over time or where multiple functions need to be performed.

Reconfigurable hardware can be tailored to specific tasks, often resulting in better performance compared to general-purpose processors. Engineers can quickly test and iterate on hardware designs, leading to faster development cycles. By reusing the same hardware for different tasks, overall costs can be reduced, especially in systems where different functionalities are needed at different times.

Reconfigurable hardware on general-purpose GPUs (GPGPUs) specialized for transcendental functions combines the flexibility of reconfigurable hardware with the massive parallel processing power of GPUs. This approach aims to optimize the computation of transcendental functions such as exponential, logarithmic, trigonometric, and hyperbolic functions.

Executing functions on the accelerated path 232 refers to the process of optimizing the computation of certain functions to achieve higher performance compared to standard execution. This typically involves using specialized hardware, optimized algorithms, and advanced techniques to perform these functions more quickly and efficiently. In the example embodiment, the functions are transcendental functions that are executed on the multiple reconfigurable hardware function units 115. The benefits of using the multiple reconfigurable hardware function units 115 to execute the transcendental functions include increased performance, energy efficiency, and enhanced capabilities. The time required to perform complex computations is reduced thus, enabling faster processing and response times in applications. Optimized hardware can perform computations with lower power consumption, which is beneficial for battery-operated devices and large-scale data centers. Using specialized hardware allows for more complex and resource-intensive applications, such as real-time simulations, advanced graphics rendering, and large-scale machine learning models to be processed by the GPU 100.

The multiple reconfigurable hardware function units 115 may be programmed with a table and addition-based accelerated function 120.

A table and addition-based accelerated function 120 is a technique used in computing to speed up the evaluation of functions, especially those that are computationally intensive. This method relies on precomputed tables and addition operations to quickly approximate or exactly calculate function values.

Precomputed tables may include lookup tables (LUTs). These are arrays where each entry corresponds to the precomputed value of the function for a specific input. Instead of computing the function value from scratch each time, the program can simply look up the precomputed value. These are arrays where each entry corresponds to the precomputed value of the function for a specific input. Instead of computing the function value from scratch each time, the program can simply look up the precomputed value.

Addition operations include addition chains and polynomial approximations. For addition chains, some functions can be decomposed into a series of addition operations. For instance, multiplication can be done using addition in certain scenarios (e.g., using logarithms and exponentiation). For polynomial approximations, functions can be approximated using polynomials, and evaluating these polynomials can be done efficiently using addition and multiplication. Techniques like Horner's method can be employed to evaluate polynomials using a minimal number of operations.

FIG. 2 illustrates identifying transcendental functions during compile time and executing the transcendental functions on an accelerated path during runtime, according to an example.

At compile time 205, a compiler 210 scans the source code 212 to identify transcendental functions 214 such as sin( ) 215, cos( ) 216, exp( ) 217, etc. The compiler 210 marks the calls with the transcendental functions 214 with a marker 220. The marking block or marked blocks 222 involves marking the block of instructions that contain or include the transcendental functions 214.

In operation, the process involves identifying the transcendental functions 214 at compile time 205 from the source code 212. During source code analysis, the compiler 210 scans the source code 212 to identify transcendental function calls such as sin( ) 215, cos( ) 216, exp( ) 217, etc. This involves parsing the code and building an abstract syntax tree (AST), where function calls are represented as nodes. Many compilers have built-in recognition for common transcendental functions, often referred to as intrinsics. These functions are matched against a predefined list of known transcendental functions. The compiler 210 may, e.g., transform the source code into an intermediate representation (IR) like LLVM IR.

During this transformation, transcendental function calls are marked explicitly in the IR (i.e., the marking block 222). For example, a call to sin(x) might be represented as an intrinsic function call in LLVM IR: llvm.sin. The compiler 210 inserts metadata or specific instructions in the IR to indicate that a block of code contains transcendental functions 214. This can involve tagging the beginning and end of instruction blocks that compute transcendental functions 214. These marks or markers 220 help the backend of the compiler 210 and the runtime to identify and optimize these sections specifically. Code generation then takes place by using the markers 220 to generate appropriate instructions, e.g., to trigger the multiple reconfigurable hardware function units 115 (FIG. 1) to execute the identified transcendental functions 214.

At runtime 225, the marked blocks 222 (or blocks of instructions) can be executed with the accelerated path 232 reserved for or designated for the execution of the transcendental functions 214. Thus, at runtime 225, the transcendental function blocks are identified. The GPU 100 decodes the instructions in the execution stream. Instructions previously marked or identified as transcendental functions 214 (during compile time 205) are recognized. These instructions may carry metadata tags or specific opcodes indicating that they belong to transcendental function blocks.

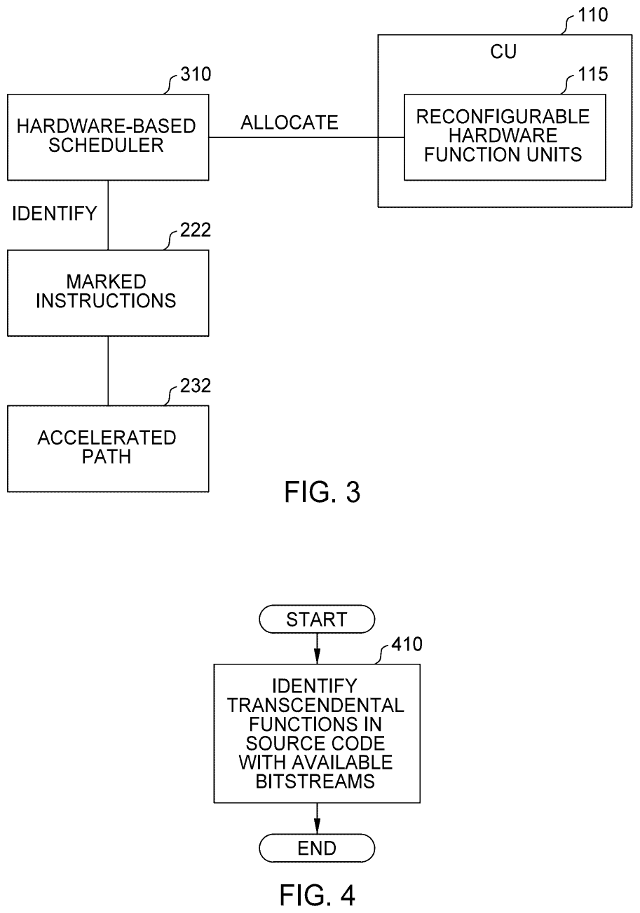

FIG. 3 illustrates using a hardware-based scheduler to allocate the execution of the transcendental functions to one or more of the multiple reconfigurable hardware function units, according to an example.

A hardware-based scheduler 310 identifies the marked blocks 222 including the transcendental functions 214 and runs them on the accelerated path 232. The hardware-based scheduler 310 allocates the marked blocks 222 to one or more of the plurality of CUs 110 including the multiple reconfigurable hardware function units 115. Stated differently, the hardware-based scheduler 310 allocates the marked blocks 222 (or instructions) to one or more of the multiple reconfigurable hardware function units 115.

In operation, the hardware-based scheduler 310 monitors the instruction pipeline for the tagged or marked transcendental function blocks. Once identified, the hardware-based scheduler 310 allocates the necessary resources for execution. This includes determining if reconfigurable hardware functions units 115 are available and suitable for the task. If resources are currently busy, the hardware-based scheduler 310 may queue the tasks, ensuring they are executed as soon as the required resources are free.

When a transcendental function block is detected, the hardware-based scheduler 310 triggers the programming of these reconfigurable units. This involves loading the appropriate bitstream or configuration that allows the reconfigurable hardware to perform the desired transcendental function efficiently and setting up the accelerated data paths to and from the reconfigurable units to ensure data flows correctly between the main processing units and the reconfigurable hardware. Once programmed, the reconfigurable hardware units execute the transcendental functions only on the accelerated data path. These units can process these functions more efficiently than general-purpose processors due to their specialized configuration. Multiple reconfigurable units may be programmed and executed in parallel, leveraging the parallel nature of GPUs. By leveraging reconfigurable hardware units, systems can achieve significant performance improvements for computationally intensive tasks like transcendental functions 214, adapting dynamically to the workload at runtime.

Implementing specialized units or circuits (i.e., the multiple reconfigurable hardware function units 115) within the GPU 100 dedicated to computing transcendental functions 214 can be beneficial. This can significantly speed up calculations that are commonly used in various applications. Using reconfigurable compute units within the GPU 100 to dynamically adapt to different transcendental functions 214 based on the workload can also be beneficial. For instance, certain parts of the GPU 100 could be reconfigured to efficiently handle exponential calculations for one task and trigonometric calculations for another. Integrating FPGAs with GPUs to combine the flexibility of reconfigurable hardware with the parallel processing capabilities of GPUs may also prove beneficial. The FPGA can be configured to accelerate specific transcendental functions 214 while the GPU 100 handles general-purpose computations (i.e., other GPU instructions). As such, the GPU becomes faster.

Making a GPU faster offers numerous benefits across various fields, from gaming and professional graphics to scientific research and machine learning. Faster GPUs provide for improved gaming experience, a boost in professional graphics, enhanced artificial intelligence (AI) and machine learning (ML), optimized data center operations, support for emerging technologies, and enhanced user experience in everyday applications. Faster GPUs can render more frames per second, resulting in smoother gameplay and more responsive controls. Faster GPUs allow for higher resolutions, better textures, and more detailed graphics, improving the overall visual experience. Faster GPUs support advanced graphics features like real-time ray tracing, leading to more realistic lighting, shadows, and reflections. Higher performance GPUs can handle more simultaneous tasks, improving the efficiency of data center operations. While faster GPUs can consume more power, advancements in GPU design often focus on improving performance per watt, leading to more energy-efficient data centers. Faster GPUs offer significant benefits across a wide range of applications and industries. They improve performance, efficiency, and capabilities, driving advancements in gaming, professional graphics, AI, scientific research, and beyond.

Moreover, the number of reconfigurable hardware units (i.e., the multiple reconfigurable hardware function units 115) in a compute unit of the plurality of CUs 110 of the GPU 100 is determined by several key factors, including chip area, power budget, and overall design goals.

Regarding chip area, the total physical area available on the GPU die limits the number of reconfigurable units that can be integrated. Each reconfigurable unit occupies a certain amount of chip area, which includes the actual FPGA logic, interconnects, memory blocks, and other supporting circuitry. Designers should balance the allocation of chip area between reconfigurable units and other essential GPU components such as shader cores, texture units, memory controllers, and caches. Increasing the number of reconfigurable units may require reducing the area allocated to other components. Advanced process technologies (e.g., 7 nm, 5 nm, etc.) can provide more transistors per unit area, allowing for more reconfigurable units or more powerful units within the same chip area.

Regarding power budget, each reconfigurable unit consumes power, both dynamically (during active computation) and statically (leakage power when idle). The total power budget for the GPU constrains how many reconfigurable units can be included without exceeding thermal and electrical limits. Effective thermal management solutions, such as heat sinks, fans, and liquid cooling, influence the power budget. Efficient cooling can allow for a higher power budget, enabling more reconfigurable units. Advances in low-power design techniques and power gating can reduce the power consumption of reconfigurable units, allowing more units to be integrated within the same power budget.

Additional design considerations pertain to performance goals. The specific performance goals of the GPU influence the number and type of reconfigurable units. For instance, a GPU designed for scientific computing may prioritize more reconfigurable units to handle a wide range of computations, while a gaming GPU may allocate more area to shader cores and texture units. Reconfigurable units provide flexibility for handling various tasks, but this flexibility comes at the cost of area and power efficiency compared to fixed-function units. Designers should balance the need for flexibility with the efficiency of specialized hardware. The complexity of integrating reconfigurable units, including the required interconnects and control logic, affects the overall design. Simplifying the integration can save area and power, allowing more units to be included.

The cost of manufacturing GPUs with a higher number of reconfigurable units can be higher due to increased silicon area and complexity. Designers may consider the target market and price point when determining the number of reconfigurable units. Higher complexity designs can lead to lower manufacturing yields, increasing costs. Designers often need to find a balance that maximizes performance while maintaining acceptable yield rates.

The integration of reconfigurable hardware units in a GPU involves careful consideration of chip area, power budget, and design trade-offs. Designers should balance these factors to achieve the desired performance, flexibility, and efficiency while meeting economic and manufacturing constraints. By optimizing the allocation of resources, GPUs can effectively leverage reconfigurable units to enhance their computational capabilities.

In another example, the number of transcendental functions per kernel that can be accelerated is limited by the numbers of reconfigurable HW units per CU. The decision can be made at the runtime to accelerate frequently executed transcendental functions at runtime. Alternatively, an application developer can provide compiler hints to prioritize acceleration of certain functions. Stated differently, when the number of reconfigurable hardware units in CUs of a GPU is limited, the ability to accelerate transcendental functions in a given kernel is correspondingly restricted. To manage this limitation, only a subset of transcendental functions may be accelerated at runtime.

For example, during compilation, all transcendental functions within a kernel are identified and tagged. This includes functions such as sin( ), cos( ), exp( ), and log( ). The compiler can assign priorities to these functions based on their frequency of use or computational cost. More frequently used or computationally expensive functions may be given higher priority for acceleration. In another example, a hardware-based or software-based runtime scheduler is responsible for managing the limited reconfigurable hardware units. Before a kernel execution, the scheduler can check the availability of reconfigurable units. The scheduler can employ, e.g., an algorithm to select which transcendental functions to accelerate based on current resource availability and priorities assigned during compilation. By carefully managing and scheduling the limited reconfigurable hardware resources, GPUs can effectively accelerate a subset of transcendental functions, improving performance while maintaining flexibility and efficiency.

In another example, during the execution of kernels (GPU programs), the compiler detects which transcendental functions are being called. These functions are identified based on the code's operations and function calls. After identifying the transcendental functions, the system counts the number of calls or invocations for each function. This information is used to prioritize which functions are the most frequently used or critical. The detected transcendental functions are then sorted based on their invocation counts or other criteria, such as their computational cost or importance to the application's performance. Based on the sorted list, a limited number of the most critical or frequently used transcendental functions are selected for optimization. Factors influencing this selection might include the frequency of function calls, their impact on performance, and the complexity of the function. The selected transcendental functions are executed using an accelerated data path, which refers to using specialized hardware or optimized software paths designed to speed up these specific functions. The benefits of processing a limited number of transcendental functions includes providing for increased performance and more efficient resource utilization. Accelerating transcendental functions improves overall kernel performance, especially for applications where these functions are computationally intensive. By focusing on the most critical functions, computational resources are used more effectively, providing better performance and efficiency.

By detecting, counting, and selecting transcendental functions based on their usage and impact, and executing them on accelerated data paths, performance can be significantly enhanced. This process involves leveraging specialized hardware and optimized algorithms to achieve faster and more efficient computations.

FIG. 4 illustrates a flowchart for identifying transcendental functions, according to an example.

At block 410, transcendental functions are identified in source code. The transcendental functions are identified at compile time from the application source code. During source code analysis, the compiler scans the source code to identify transcendental function calls such as sin( ), cos( ), exp( ), log( ), etc.

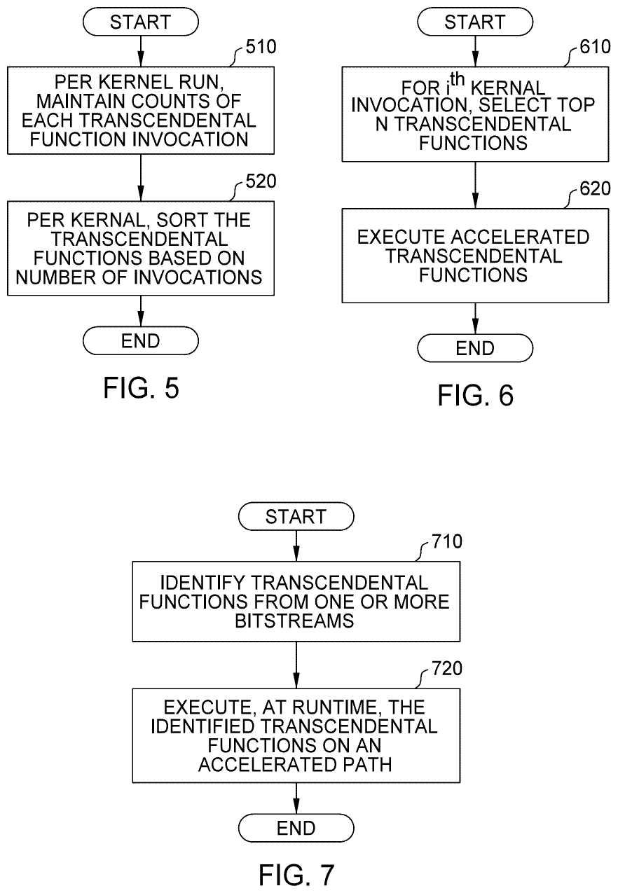

FIG. 5 illustrates a flowchart for sorting transcendental functions, according to an example.

At block 510, after each kernel run, a count is maintained for each transcendental function invocation. The kernel run refers to the execution of a kernel function on, e.g., a GPU. The kernel function is a piece of code designed to be executed by multiple threads in parallel on the GPU. After the kernel run, there is a process for counting how many times the transcendental functions were called or invoked.

At block 520, the detected transcendental functions are sorted based on the number of calls or invocations. The collected data may include the names of the transcendental functions and their respective invocation counts. The collected data may be sorted in an ascending order (least called function first) or a descending order (most called function first) depending on the desired analysis.

FIG. 6 illustrates a flowchart for executing the transcendental functions on an accelerated path, according to an example.

At block 610, for the i^{th} kernel invocation, the top N transcendental functions are selected. For example, the most called functions may be selected. The kernel function is executed multiple times on the GPU, each run potentially involving different inputs or workloads. For each kernel run, the number of invocations for each transcendental function is counted. This data may be collected for each individual run. The data from the multiple runs may be aggregated. The aggregated invocations counts are sorted to identify the most frequently called transcendental functions. A threshold or a fixed number is used to select the top transcendental functions with the highest invocation counts.

At block 620, the selected transcendental functions are executed on an accelerated path. The accelerated data path handles the flow and processing of data pertaining to the detected transcendental functions. The accelerated data path may include, e.g., functional units, arithmetic logic units (ALUs), registers, buses, and memory.

FIG. 7 illustrates a method for implementing the GPU of FIG. 1, according to an example.

At block 710, the transcendental functions are identified from one or more bitstreams. The transcendental functions are identified at compile time from the application source code.

At block 720, at runtime, the identified transcendental functions are executed on the accelerated data path. The accelerated data path performs data processing related to the identified transcendental functions only. The accelerated data path does not perform other GPU instructions. Such other GPU instructions can include, e.g., arithmetic and logical instructions, memory instructions, control flow instructions, and synchronization instructions. Such other instructions are handled by the GPU 100.

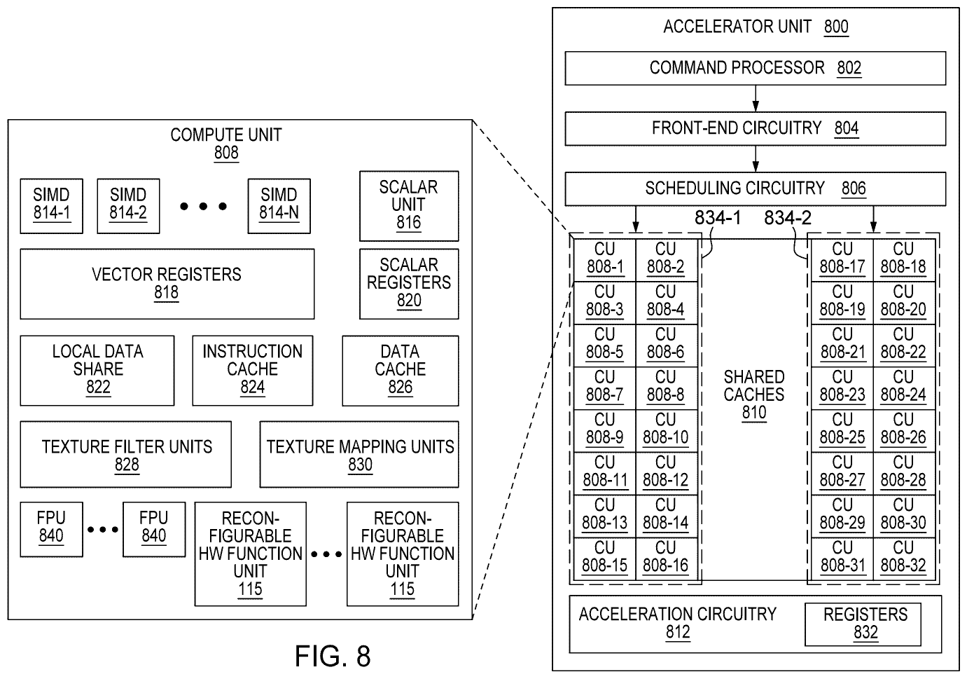

FIG. 8 is a block diagram of an accelerator unit (AU) configured to execute workloads for applications running on a processing system, in accordance with some embodiments.

FIG. 8 presents an AU 800 configured to execute workloads for one or more applications running on a processing system. These applications include, for example, compute applications, graphics applications, or both each configured to issue respective series of instructions, also referred to herein as “threads,” to a central processing unit (CPU) of the processing system. Compute applications, when executed by a processing system, cause the processing system to perform one or more computations, such as machine-learning, neural network, high-performance computing, or databasing computations. Further, graphics applications, when executed by a processing system, cause the processing system to render a scene including one or more graphics objects and, as an example, output the scene on a display. The instructions issued to the CPU from these applications, for example, include groups of threads, also referred to herein as “workgroups,” to be executed by AU 800. To perform these workgroups, AU 800 includes one or more vector processors, coprocessors, GPUs, general-purpose GPUs, non-scalar processors, highly parallel processors, artificial intelligence (AI) processors, inference engines, machine-learning (ML) processors, or any combination thereof. As an example, AU 800 includes one or more command processors 802, front-end circuitry 804, scheduling circuitry 806, compute units 808, shared caches 810, and acceleration circuitry 812.

A command processor 802 of AU 800 is configured to receive, from the CPU, a command stream indicating one or more workgroups to be executed. As an example, based on a compute application running on the processing system, the command processor 802 receives a command stream indicating workgroups that involve compute operations such as matrix multiplication, addition, subtraction, and the like to be performed. As another example, based on a graphics application running on the processing system, the command processor 802 receives a command stream indicating workgroups that include draw calls for a scene to be rendered. After receiving a command stream, the command processor 802 parses the command stream and issues respective instructions of the indicated workgroups to front-end circuitry 804, scheduling circuitry 806, or both. As an example, based on a command stream from a graphics application, the command processor 802 issues one or more draw calls to front-end circuitry 804 that includes one or more vertex shaders, polygon list builders, and the like. From the instructions issued from the command processor 802, front-end circuitry 804 is configured to position geometry objects in a scene, assemble primitives in a scene, cull primitives, perform visibility passes for primitives in a scene, generate visible primitive lists for a scene, or any combination thereof. For example, based on a set of draw calls received from a command processor 802, front-end circuitry 804 determines a list of primitives to be rendered for a scene. After determining a list of primitives to be rendered for a scene, the front-end circuitry 804 issues one or more draw calls (e.g., a workgroup) associated with the primitives in the list of primitives to scheduling circuitry 806.

Based on the instructions of the workgroups received from a command processor 802, front-end circuitry 804, or both, scheduler circuitry 806 is configured to provide data indicating threads (e.g., operations for these threads) to be executed for these workgroups to one or more compute units 808. Each compute unit 808 is configured to support the concurrent execution of two or more threads of a workgroup. For example, each compute unit 808 is configured to concurrently execute a predetermined number of threads referred to herein as a “wavefront.” Based on the size of the wavefront of a compute unit 808, scheduler circuitry 806 schedules one or more groups of threads of the workgroup, also referred to herein as “waves,” to be executed by the compute unit 808. As an example, scheduler circuitry 806 first updates one or more registers of a compute unit 808 such that the compute unit 808 is configured to execute a first group of waves of the workgroup. After the compute unit 808 has executed the first group of waves, scheduler circuitry 806 updates one or more registers of the compute unit 808 to schedule a second group of waves of the workgroup to be executed by the compute unit 808. To execute these waves, each compute unit is connected to one or more shared caches 810 that each include a volatile memory, non-volatile memory, or both accessible by one or more compute units 808. These shared caches 810, for example, are configured to store data (e.g., register files, values, operands, instructions, variables) used in the execution of one or more waves, data resulting from the performance of one or more waves, or both. Because a shared cache 810 is accessible by two or more compute units 808, a first compute unit 808 is enabled to provide results from the execution of a first wave to a second compute unit 808 executing a second wave. Though the example embodiment presented in FIG. 8 shows AU 800 as including 32 compute units (808-1 to 808-32), in other implementations, AU 800 can include any number of compute units 808.

Each compute unit 808 includes one or more single instruction, multiple data (SIMD) units 814, a scalar unit 816, vector registers 818, scalar registers 820, local data share 822, instruction cache 824, data cache 826, texture filter units 828, texture mapping units 830, or any combination thereof. A SIMD unit 814 (e.g., a vector processor) is configured to concurrently perform multiple instances of the same operation for a wave. For example, a SIMD unit 814 includes two or more lanes each including an arithmetic logic unit (ALU) and each configured to perform the same operation for the threads of a wave. Though the example embodiment presented in FIG. 8 shows a compute unit 808 including three SIMD units (814-1, 814-2, 814-N) representing an N number of SIMD units, in other implementations, a compute unit 808 can include any number of SIMD units 814. Further, as an example, the size of a wavefront supported by AU 800 is based on the number of SIMD units 814 included in each compute unit 808. To determine the operations performed by the SIMD units 814, each compute unit 808 includes vector registers 818 formed from one or more physical registers of AU 800. These vector registers 818 are configured to store data (e.g., operands, values) used by the respective lanes of the SIMD units 814 to perform a corresponding operation for the wave. Additionally, each compute unit 808 includes a scalar unit 816 configured to perform scalar operations for the wave. As an example, the scalar unit 816 includes an ALU configured to perform scalar operations. To support the scalar unit 816, each compute unit 808 includes scalar registers 820 formed from one or more physical registers of accelerator unit 800. These scalar registers 820 store data (e.g., operands, values) used by the scalar unit 816 to perform a corresponding scalar operation for the wave.

Further, each compute unit 808 includes a local data share 822 formed from a volatile memory (e.g., random-access memory) accessible by each SIMD unit 814 and the scalar unit 816 of the compute unit 808. That is to say, the local data share 822 is shared across each wave concurrently executing on the compute unit 808. The local data share 822 is configured to store data resulting from the execution of one or more operations for one or more waves, data (e.g., register files, values, operands, instructions, variables) used in the execution of one or operations for one or more waves, or both. As an example, the local data share 822 is used as a scratch memory to store results necessary for, aiding in, or helpful for the performance of one or more operations by one or more SIMD units 814. The instruction cache 824 of a compute unit 808, for example, includes a volatile memory, non-volatile memory, or both configured to store the instructions to be executed for one or more waves to be executed by the compute unit 808. Further, the data cache 826 of a compute unit 808 includes a volatile memory, non-volatile memory, or both configured to store data (e.g., register files, values, operands, variables) used in the execution of one or more waves by the compute unit 808. The instruction cache 824, data cache 826, shared caches 810, and a system memory, for example, are arranged in a hierarchy based on the respective sizes of the caches. As an example, based on such a cache hierarchy, a compute unit 808 first requests data from a controller of a corresponding data cache 826. Based on the data not being in the data cache 826, the data cache 826 requests the data from a shared cache 810 at the next level of the cache hierarchy. The caches then continue in this way until the data is found in a cache or requested from the system memory, at which point, the data is returned to the compute unit 808. Additionally, each compute unit 808 includes one or more texture mapping units 830 each including circuitry configured to map textures to one or more graphics objects (e.g., groups of primitives) generated by the compute units 808. Further, each compute unit 808 includes one or more texture filter units 828 each having circuitry configured to filter the textures applied to the generated graphics objects. For example, the texture filter units 828 are configured to perform one or more magnification operations, anti-aliasing operations, or both to filter a texture.

Each compute unit 808 includes floating point units (FPUs) 840 and the reconfigurable hardware function units 115. The FPUs 840 are specialized hardware components designed to handle arithmetic operations involving floating-point numbers, which are numbers with decimals represented in a specific format. FPUs 840 perform high-precision mathematical computations, particularly in graphics rendering, machine learning, and other GPU-accelerated applications. The reconfigurable hardware function units 115 are executed on an accelerated path 232 (FIGS. 2 and 3). During runtime 225, the marked instructions 222 are identified and allocated to the reconfigurable hardware function units 115 of the CU 808. Stated differently, the accelerator unit 800 including the CUs 808 with the reconfigurable hardware function units 115 creates and uses the accelerated path 232 to process the transcendental functions 214 separate from other tasks. The accelerated path 232 created and used by the accelerator unit 800 minimizes latency and increases throughput.

Additionally, to help perform instructions for one or more workgroups, AU 800 includes acceleration circuitry 812. Such acceleration circuitry 812 includes hardware (e.g., fixed-function hardware) configured to execute one or more instructions for one or more workgroups. As an example, acceleration circuitry 812 includes one or more instances of fixed function hardware configured to encode frames, encode audio, decode frames, decode audio, display frames, output audio, perform matrix multiplication, or any combination thereof. To schedule instructions for execution on such hardware, scheduling circuitry 806 is configured to update one or more physical registers 832 of AU 800 associated with the hardware. In some cases, AU 800 includes one or more compute units 808 grouped into one or more shader engines 834.

Referring to the embodiment presented in FIG. 8, for example, AU 800 includes compute units 808-1 to 808-16 grouped in a first shader engine 834-1 and compute units 808-17 to 808-32 grouped in a second shader engine 834-2. Such shader engines 834, for example, are configured to execute one or more workgroups (e.g., one or more compute kernels) for an application and include one or more compute units 808, graphics processing hardware (e.g., primitive assemblers, rasterizers), one or more shared caches 810, render backends, or any combination thereof. Though the embodiment presented in FIG. 8 shows AU 800 as including two shader engines (834-1, 834-2), in other implementations, AU 800 can include any number of shader engines (834-1, 834-2).

In conclusion, making a GPU faster offers numerous benefits across various fields, from gaming and professional graphics to scientific research and machine learning. Faster GPUs provide for improved gaming experience, a boost in professional graphics, enhanced artificial intelligence (AI) and machine learning (ML), optimized data center operations, support for emerging technologies, and enhanced user experience in everyday applications.

Faster GPUs can render more frames per second, resulting in smoother gameplay and more responsive controls. Faster GPUs allow for higher resolutions, better textures, and more detailed graphics, improving the overall visual experience. Faster GPUs support advanced graphics features like real-time ray tracing, leading to more realistic lighting, shadows, and reflections. Higher performance GPUs can handle more simultaneous tasks, improving the efficiency of data center operations. While faster GPUs can consume more power, advancements in GPU design often focus on improving performance per watt, leading to more energy-efficient data centers. Faster GPUs offer significant benefits across a wide range of applications and industries. They improve performance, efficiency, and capabilities, driving advancements in gaming, professional graphics, AI, scientific research, and beyond.

The example embodiments disclose a system and method to accelerate processing of transcendental functions on GPUs. The system and method involves using transcendental functions on reconfigurable hardware on GPUs. Each CU will have a set of reconfigurable HW function units. The number of reconfigurable HW function units per CU are determined based on the available chip area and power budget. The reconfigurable HW function unit(s) will be programmed at runtime to execute the transcendental functions via an accelerated path. The proposed reconfigurable transcendental hardware function unit executes transcendental functions on an accelerated path. The reconfigurable hardware may be programmed with a Tables-and-addition-based accelerated function to execute the transcendental functions. The advantages of such configuration include faster processing of the transcendental functions on the GPU, executing the transcendental function processing on an accelerated path, and decreasing pressure on the FPUs and registers of the GPU.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system. ” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A system comprising:
at least one physical processor; and
physical memory comprising computer-executable instructions that, when executed by the physical processor, cause the physical processor to:
identify, using multiple reconfigurable hardware function units, transcendental functions from one or more bitstreams; and
execute, at runtime, the identified transcendental functions on an accelerated path.

2. The system of claim 1, wherein the physical processor is a graphics processing unit (GPU).

3. The system of claim 2, wherein the accelerated path is different than paths used to process existing GPU instructions.

4. The system of claim 1, wherein the multiple reconfigurable hardware function units are programmed with a table and addition based accelerated function.

5. The system of claim 1, wherein a number of the multiple reconfigurable hardware function units is based on chip area and power budget.

6. The system of claim 1, wherein the transcendental functions are identified at compile time, by a compiler, from application source code.

7. The system of claim 6, wherein the compiler marks blocks of instructions that include the transcendental functions.

8. The system of claim 1, wherein a hardware-based scheduler triggers programming of the multiple reconfigurable hardware function units.

9. The system of claim 8, wherein the programming of the multiple reconfigurable hardware function units occurs at a next invocation of a transcendental function from the identified transcendental functions.

10. A non-transitory computer-readable medium storing instructions that, when executed by a processor, cause the processor to:
identify, at compile time, using multiple reconfigurable hardware function units, transcendental functions from one or more bitstreams; and
execute, at runtime, the identified transcendental functions on an accelerated path different than paths used to process existing GPU instructions.

11. The non-transitory computer-readable medium of claim 10, wherein the multiple reconfigurable hardware function units are programmed with a table and addition based accelerated function.

12. The non-transitory computer-readable medium of claim 10, wherein a number of the multiple reconfigurable hardware function units is based on chip area and power budget.

13. The non-transitory computer-readable medium of claim 10, wherein the transcendental functions are identified by a compiler from application source code.

14. The non-transitory computer-readable medium of claim 13, wherein the compiler marks blocks of instructions that include the transcendental functions.

15. The non-transitory computer-readable medium of claim 10, wherein a hardware-based scheduler triggers programming of the multiple reconfigurable hardware function units.

16. The non-transitory computer-readable medium of claim 15, wherein the programming of the multiple reconfigurable hardware function units occurs at a next invocation of a transcendental function from the identified transcendental functions.

17. A method comprising:
identifying, using multiple reconfigurable hardware function units, transcendental functions from one or more bitstreams; and
executing, at runtime, the identified transcendental functions on an accelerated path.

18. The method of claim 17, wherein the accelerated path is different than paths used for processing existing GPU instructions.

19. The method of claim 17, wherein the multiple reconfigurable hardware function units are programmed with a table and addition based accelerated function.

20. The method of claim 17, wherein a hardware-based scheduler triggers programming of the multiple reconfigurable hardware function units.
